(19) United States
(12) Patent Application Publication
(10) Pub. No.: US 2007/0115528 A1
(43) Pub. Date: May 24, 2007

(54) Multi-beam scanning unit

(75) Inventors: Hyung-soo Kim, Suwon-si (KR); Jae-hwan Yoo, Yongin-si (KR); Won-ho Seo, Suwon-si (KR); In-ho Yoon, Suwon-si (KR); Jong-min Lee, Suwon-si (KR); Se-tae Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co. Ltd., Suwon-si (KR)

(21) Appl. No.: 11/493,672

(22) Filed: Jul. 27, 2006

(30) Foreign Application Priority Data
Nov. 23, 2005 (KR) 10-2005-0112241

(51) Int. Cl. G02B 26/08

(52) U.S. Cl. 359/204; 359/198

(57) ABSTRACT

A multi-beam scanning unit includes a light source having a plurality of light emitting portions, each light emitting portion emitting a laser beam, and a beam deflector deflecting each of the laser beams emitted from the light emitting portions in a main scanning direction of a photosensitive medium. The light emitting portions are arranged in a line on a light exit surface of the light source, and an angle A between a section on a light exit surface of the light source corresponding to a sub-scanning direction that is a direction in which the photosensitive medium moves and a section connecting the light emitting portions satisfies the following inequalities: 0°<A≦35° or 55°≦A≦80°.

### CROSS-REFERENCE TO RELATED APPLICATIONS

This application claims the benefit of Korean Patent Application No. 10-2005-0112241, filed on Nov. 23, 2005, in the Korean Intellectual Property Office, the disclosure of which is incorporated herein in its entirety by reference.

### BACKGROUND OF THE INVENTION

1. Field of the Invention

The present general inventive concept relates to a multi-beam scanning unit capable of forming a plurality of scanning lines onto a photosensitive medium, and more particularly, to a multi-beam scanning unit which can correct for a change in an amount of light due to interference of a laser beam without a correction circuit or a mechanical adjustment structure.

2. Description of the Related Art

A multi-beam scanning unit which simultaneously scans a plurality of scanning lines can exhibit scanning performance that is greater than or equal to a single beam scanning unit using a single beam while reducing a drive velocity of a beam deflector, for example, a number of rotations of a rotary polygon mirror. Accordingly, the multi-beam scanning unit can output the scanning lines at high speed even for a high resolution and embody a reliable and low noise apparatus according to a decrease in the drive velocity of the beam deflector. Therefore, the multi-beam scanning unit is applied to image forming systems such as laser printers, digital copiers, and facsimile machines.

The multi-beam scanning unit includes a semiconductor laser having a plurality of light emitting portions that can be independently controlled. The multi-beam scanning unit can manage a distance between the scanning lines simultaneously formed on a photosensitive medium in a particular range by setting a distance between the light emitting portions. Also, constituent elements except for the semiconductor laser, for example, a collimating lens, a rotary polygon mirror, and an f-θ lens, can be configured identically with respect to the single beam scanning unit which scans a single laser beam.

A conventional multi-beam scanning unit has a problem that light interference is generated due to a change in an amount of light. FIG. 1 illustrates a procession of a light emitted by a laser light source 1 having first and second light emitting portions 3 and 5 that independently emit laser beams. Referring to FIG. 1, phase combination occurs between laser beams emitted by the first and second light emitting portions 3 and 5 by instant cross-talk during high speed operation of the laser light source 1 so that a constructive or destructive interference phenomenon occurs in a superposition portion between the two laser beams. The interference phenomenon between the laser beams causes a change in an optical power in a particular portion in a scanning section. Thus, when a latent image corresponding to black is formed on a front surface of a photosensitive medium by emitting a laser beam that is continuously turned on at the first and second light emitting portions 3 and 5, an irregular white line may be generated in a main scanning direction due to the change in the optical power when an image is formed.

Japanese Patent Publication No. 2005-055538 entitled “Multi-Beam Laser Emitting Unit And Image Forming Apparatus” published on Mar. 3, 2005 discloses an apparatus having a structure to prevent deterioration of an image due to the interference phenomenon between laser beams. In the apparatus, a high frequency wave oscillation circuit for superposition of a high frequency wave signal is added to at least one of the light emitting portions which constitutes a multi-beam light source to multiplex an oscillation longitudinal mode and restrict the interference between the laser beams.

When the interference phenomenon between the laser beams is restricted by adding the high frequency wave oscillation circuit, a circuit for oscillating a high frequency wave of about 300 MHz or more is needed. As a result, the circuit structure becomes complicated and the cost of production increases. Accordingly, a multi-beam scanning unit which can reduce interference between beams without a costly or complicated correction circuit is needed.

### SUMMARY OF THE INVENTION

The present general inventive concept provides a multi-beam scanning unit which can restrict the interference phenomenon between laser beams without a correction circuit or additional mechanical adjustment structure, by changing an optical arrangement of a multi-beam light source.

Additional aspects and advantages of the present general inventive concept will be set forth in part in the description which follows and, in part, will be obvious from the description, or may be learned by practice of the general inventive concept.

The foregoing and/or other aspects of the present inventive concept are achieved by providing a multi-beam scanning unit which includes a light source having a plurality of light emitting portions, each light emitting portion emitting a laser beam, and a beam deflector deflecting each of the laser beams emitted from the light emitting portions in a main scanning direction of a photosensitive medium. The light emitting portions are arranged in a line on a light exit surface of the light source, and an angle A between a section on the light exit surface of the light source corresponding to a sub-scanning direction that is a direction in which the photosensitive medium moves and a section connecting the light emitting portions satisfies Inequality 1 or Inequality 2 which are:
0°<A≦35° [Inequality 1]
55°≦A≦80° [Inequality 2].

The foregoing and/or other aspects of the present inventive concept may also be achieved by providing. a multi-beam scanning device which includes a light source having a plurality of light emitting portions to emit light beams through a light exit plane thereof onto a photosensitive medium, centers of the light emitting portions being arranged along a first line on the exit plane, and a beam guide unit to guide the light beams from the light source to the photosensitive medium, wherein an angle between the first line and a second line corresponding to a sub-scanning direction in the the photosensitive medium moves is set to a predetermined angle to eliminate interference between the light emitting portions.

The foregoing and/or other aspects of the present inventive concept may also be achieved by providing a method of correcting interference in a multi-beam scanning device, the method including emitting light from a light source having two light emitting portions through a light exit plane onto a photosensitive medium, centers of the light emitting portions being arranged along a first line on the light exit plane, and controlling to within a predetermined amount an angle between the first line and a second line corresponding to a sub-scanning direction in which the photosensitive medium moves to eliminate interference between the light emitting portions.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a change in an amount of light due to an interference phenomenon of a conventional multi-beam scanning unit;

FIG. 2 illustrates an optical arrangement of a multi-beam scanning unit according to an embodiment of the present general inventive concept;

FIG. 3 illustrates a beam path in a sub-scanning direction of the multi-beam scanning unit of FIG. 2;

FIG. 4 illustrates the optical arrangement of a light source of the multi-beam scanning unit of FIG. 2;

FIGS. 5A and 5B illustrate a degree of light interference between two neighboring spots according to a comparative example and the present embodiment;

FIG. 6 illustrates a positional relationship when the light beam emitted by the light source of the multi-beam scanning unit of FIG. 2 forms an image on a photosensitive medium;

FIG. 7 is a graph illustrating change in light source pitch and optical system magnification according to change in inclination angle of the light source of the multi-beam scanning unit of FIG. 2; and

FIG. 8 is a graph illustrating change in sizes of spots formed on a photosensitive medium in a main scanning direction and a sub-scanning direction according to change in inclination angle of the light source of the multi-beam scanning unit of FIG. 2.

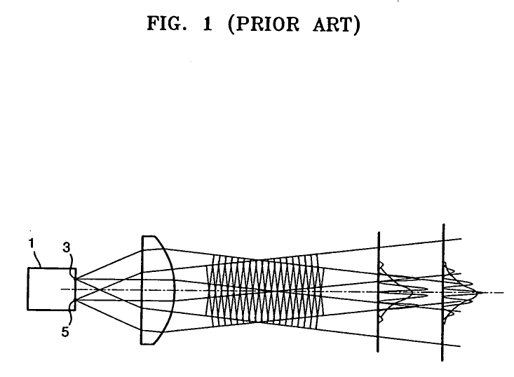

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

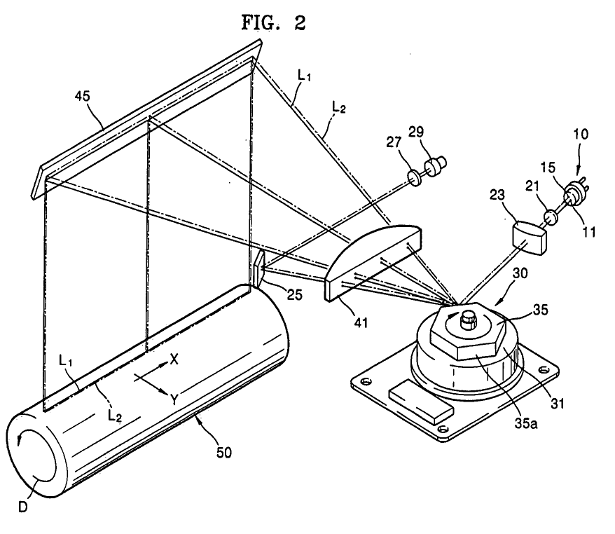

Referring to FIGS. 2, 3, and 4, a multi-beam scanning unit according to an embodiment of the present inventive concept scans light onto a photosensitive medium 50 having a light exposed surface moving in a direction D, and includes a light source 10 to emit a plurality of laser beams to be separated by a predetermined distance in a sub-scanning direction Y and a beam deflector 30 to deflect each of the laser beams emitted by the light source 10 in a main scanning direction X of the photosensitive medium 50.

The light source 10 includes a plurality of light emitting portions to respectively emit laser beams corresponding to image signals while being controlled in an on/off manner. The laser beams emitted by the light source 10 are simultaneously scanned onto the light exposed surface of the photosensitive medium 50 in the sub-scanning direction Y.

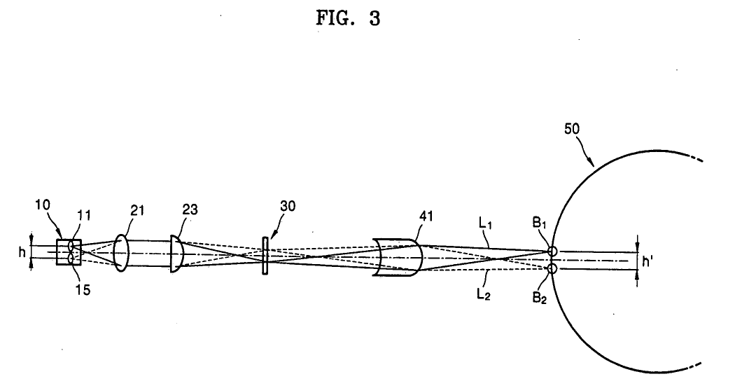

Referring to FIGS. 2 and 3, in the present embodiment, the light source 10 may include first and second light emitting portions 11 and 15. The first and second light emitting portions 11 and 15 can each include a semiconductor laser which may be formed of an edge emitting laser diode to emit a laser beam from a side surface or a vertical cavity surface emitting laser diode to emit a laser beam from an upper surface of a substrate.

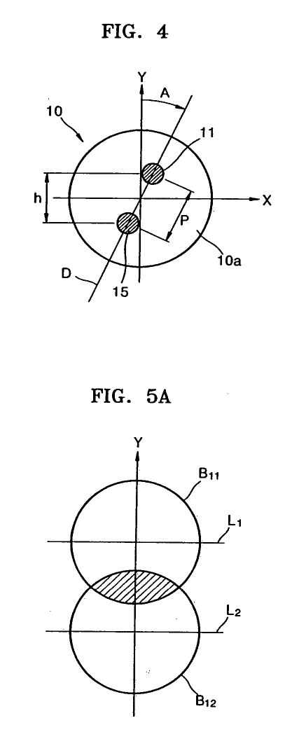

Referring to FIG. 4, a distance between a center of the first light emitting portion 11 and a center of the second light emitting portion 15, that is, a light source pitch P, is less than 100 μm, and may be about 14 μm. The light source pitch P is set for the following reasons.

Referring to FIG. 3, the distance h′ between first and second scanning lines L₁ and L₂, which are simultaneously scanned onto the photosensitive medium 50, is determined by the light source pitch P and an optical magnification of a scanning optical system that is described below.

For example, in a multi-beam scanning unit having a resolution of 600 dpi, since the distance between the scanning lines L₁ and L₂ on the photosensitive medium 50 must be about 42 μm (=1 inch/600 dots), when the optical magnification in the sub-scanning direction in the scanning optical system is designed to be 3×, the light source pitch P is about 14 μm (=42 μm/3). The optical magnification in the sub-scanning direction Y means a ratio (=h′/h) of the distance h′ between the two scanning lines L₁ and L₂ formed on the photosensitive medium 50 with respect to a distance h in the sub-scanning direction Y between centers of the first and second light emitting potions 11 and 15.

Both the optical magnification and the light source pitch P are values that can be changed. However, the light source pitch P has a limit in an amount it can be decreased due to the characteristic of the light source 10 and in an amount it can be increased due to the spatial optical design. Thus, in the multi-beam scanning unit, the light source pitch P may be set to several different values and the magnification of the scanning optical system may be designed according to the several different values or a distance between the light emitting portions 11 and 15 corresponding to the sub-scanning direction Y by rotating the light source 10.

In conventional multi-beam scanning units, the light source pitch is set to 100 μm or more and an angle between a line corresponding to the sub-scanning direction and a line connecting the light source portions is set to 80-90°. That is, when a multi-beam scanning unit is configured to have a light source pitch of 100 μm and an optical magnification of 4.5×, to make the distance between the light emitting portions corresponding to the sub-scanning direction be equal to 9.4 μm (=42.3 μm/4.5), the light source is rotated by 84.6°[=cos⁻¹(9.4 μm/100 μm)]. However, when the rotation angle is set too large, the optical magnification in the sub-scanning direction is abruptly changed by only a tiny change in the rotation angle. Accordingly, an additional adjustment mechanism is needed which can precisely adjust the rotation angle as disclosed in Japanese Patent Publication No. 2000-089147.

Thus, considering the problem occurring when the light source pitch is set to 100 μm or more, in the present embodiment, the light source pitch P has a value less than 100 μm. The light source pitch P can be set to about 14 μm in order to enable a design of the scanning optical system to have a low magnification of about 3× to 4.5×, and produce an image of 600 dpi resolution.

Also, the first and second light emitting portions 11 and 15 are arranged on a straight line D on a light exit surface 10a of the light source 10 (see FIG. 4). When the light source 10 includes three or more light emitting portions, the light emitting portions may all be arranged on a straight line D.

The angle A between a segment Y on the light exit surface 10a corresponding to the sub-scanning direction that is the direction in which the photosensitive medium 50 moves and a segment D connecting the first and second light emitting portions 11 and 15 satisfies the following Inequality 1 or 2.
0°<A≦35° [Inequality 1]
55°≦A≦80° [Inequality 2].

As described above, the first and second light emitting portions 11 and 15 are arranged as above considering a change in an amount of light due to interference between the laser beams and an increase in a size of a beam spot according to the rotation angle. That is, compared to the conventional multi-beam scanning unit, the change in the amount of light due to the interference can be effectively restricted without a substantial change in the size of the beam spot.

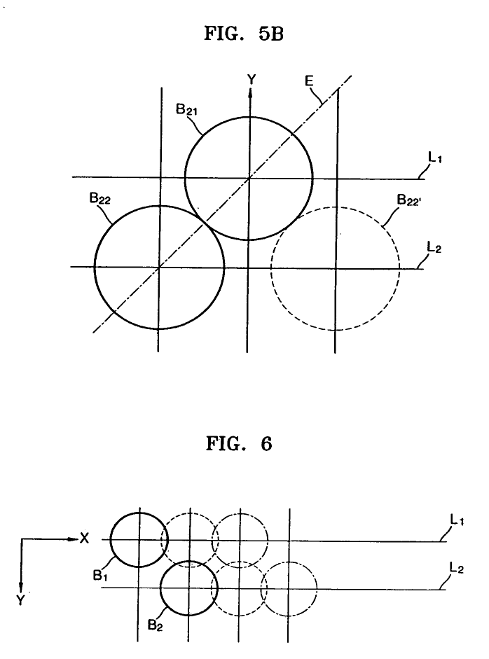

FIGS. 5A and 5B are views illustrating a degree of light interference between two neighboring spots according to a comparative example and the present embodiment, respectively. In FIGS.5A and 5B, a diameter of a beam spot formed on the photosensitive medium is 42 μm or more when a distance between the two scanning lines L₁ and L₂ is 42 μm. FIG. 5A illustrates a case in which the light source is arranged without being rotated according to a comparative example. Two beam spots B₁₁ and B₁₂ are scanned to be vertically arranged in the sub-scanning direction Y. Thus, an overlap area that is a hatched portion between the two beam spots exists. The overlap area represents an interference which causes a change in the amount of light.

FIG. 5B illustrates the light sources which are arranged by being rotated according to an embodiment of the present general inventive concept. A section E connecting the centers of two beam spots B₂₁ and B₂₂ (or B₂₂′) which are simultaneously scanned onto the photosensitive medium may be arranged to be inclined with respect to the sub-scanning direction Y Even when an overlap area exists, it is possible to make a size of the overlap area smaller or to completely make the overlap area disappear. Thus, an area affected by interference between the two scanned beams can be restricted or excluded.

FIG. 6 is a view illustrating a positional relationship when a light beam emitted by a light source of a multi-beam scanning unit of FIG. 2 forms an image on a photosensitive medium. Referring to FIG. 6, the multi-beam scanning unit according to the present embodiment simultaneously scans two beams onto positions separated a predetermined distance from each other in the sub-scanning direction Y to form scanning lines L₁ and L₂ in a main scanning direction X. Beam spots B₁ and B₂ respectively formed along the scanning lines L₁ and L₂ may be arranged to be inclined with respect to the sub-scanning direction Y.

A distance in the main scanning direction X between centers of the beam spots B₁ and B_{2,} which are respectively emitted from the first and second light emitting portion 11 and 15 and formed on the photosensitive medium 50, may be 1/2 dots or more based on a resolution of an optical system. Also, the distance in the sub-scanning direction Y between the centers of the beam spots B₁ and B₂ can be within a range of ±20% based on the resolution of the optical system. Thus, by setting the distances as above, other problems are not generated even when a difference in the positions of the beam spots in the main scanning direction X occurs according to the rotation angle of the light source. Therefore, generation of optical interference between the scanning lines L₁ and L₂ can be restricted as described with reference to FIG. 5B.

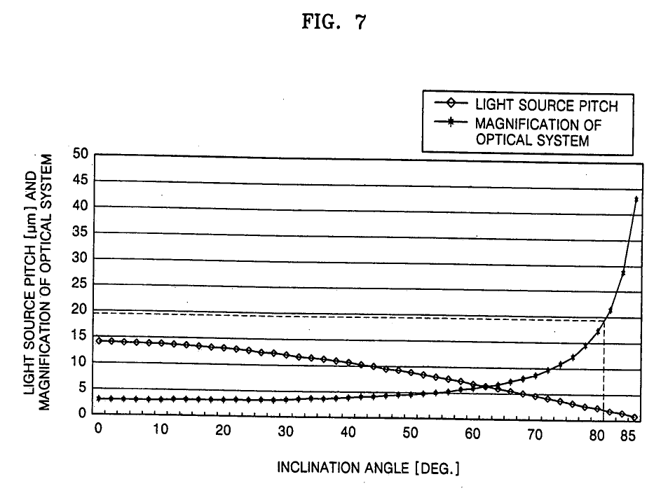

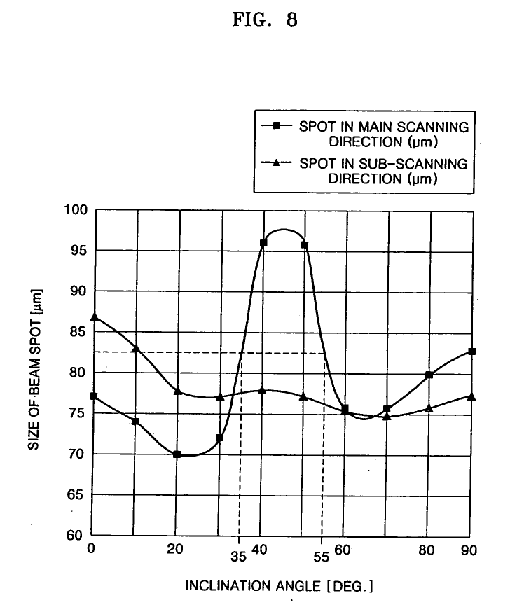

FIG. 7 is a graph illustrating a change in light source pitch and a magnification of an optical system according to a change in an inclination angle of the light source of a multi-beam scanning unit of FIG. 2. FIG. 8 is a graph illustrating the change in the sizes of spots formed on a photosensitive medium in the main scanning direction and the sub-scanning direction according to the change in the inclination angle of the light source of the multi-beam scanning unit of FIG. 2. Referring to FIG. 7 and 8, the reason for the inclination angle of the light source to be within a range defined by the Inequalities 1 and 2 will be described.

FIG. 7 illustrates a case in which the light source has a resolution of 600 dpi and the distance between the first and second light emitting portions is 14 μm. Referring to FIG. 7, it can be seen that the light source pitch P in the sub-scanning direction gradually decreases as the inclination angle of the light source increases. In order to change the magnification of an optical system, it can be seen that the magnification of the optical system is abruptly increased to 1 8X or more when the inclination angle is not less than 80°. The magnification of the beam spot in the sub-scanning direction emitted onto the photosensitive medium 50 of FIG. 2 is within a range of 1.5× to 18× considering the distance between the multi-scanned beams, the light source pitch P, and the performance of the optical system. Thus, the inclination angle A is set to be within 80° which is the upper limit of Inequality 2.

Referring to FIG. 8, when the inclination angle is a value between 35-55°, the size of the beam spot in the main scanning direction is abruptly increased over about 82 μm so that forming an image having a desired resolution of 600 dpi, for example, is difficult. Thus, when the inclination angle A is set, values outside of the ranges of the upper limit of Inequality 1 and the lower limit of Inequality 2 are excluded.

Referring back to FIG. 2, the beam deflector 30 deflects the light emitted from the light source 10 in the main scanning direction X of the photosensitive medium 50. A polygon mirror unit configured as described above may be used for the beam deflector 30. The polygon mirror unit may include a driving source 31 and a polygon mirror 35 installed to be rotatable with respect to the driving source 31. The polygon mirror 35 may include a plurality of reflecting surfaces 35a formed on the side surface thereof to deflect incident light while being rotated. The beam deflector 30 is not limited to the polygon mirror unit configured as above. A hologram disc type beam deflector which deflects incident light and a Galvano mirror type scanning unit can also be adopted as the beam deflector 30.

A collimating lens 21 and a cylindrical lens 23 may further be provided along an optical path between the light source 10 and the beam deflector 30. The collimating lens 21 condenses a multi-beam emitted from the light source 10 to make a parallel beam or a convergent-beam. The cylindrical lens 23 formed of at least one lens unit condenses an incident beam that passes through the collimating lens 21 in a direction corresponding to the main scanning direction and/or the sub-scanning direction so that a linear incident beam can be formed on the beam deflector 30.

Also, a multi-beam scanning unit according to the present embodiment may further include an f-θ lens 41 and a sync signal detection unit. The f-θ lens 41 is arranged between the beam deflector 30 and the photosensitive medium 50 and formed of at least one lens unit. The f-θ lens 41 corrects the light deflected by the beam deflector 30 at different magnifications with respect to the main scanning direction and the sub-scanning direction and then directs light toward the photosensitive medium 50.

The sync signal detection unit receives part of the beam emitted from the light source 10 to synchronize a horizontal sync of the scanned beam. To this end, the sync signal detection unit may include a sync signal detection sensor 29 to receive part of the beam deflected by the beam deflector 30 and passing through the f-θ lens 41, a mirror 25 arranged between the f-θ lens 41 and the sync signal detection sensor 29 to change a proceeding path of an incident beam, and a focusing lens 27 to focus the beam reflected by the mirror 25.

Also, a reflecting mirror 45 may be further provided between the f-θ lens 41 and the photosensitive medium 50. The reflecting mirror 45 reflects a scanned line incident from the beam deflector 30 to form the scanning lines L₁ and L₂ on the light exposed surface of the photosensitive medium 50.

As described above, in the multi-beam scanning unit configured as above according to the present general inventive concept, since an inclination angle of a light source having a plurality of light emitting portions is optimized, the interference phenomenon between laser beams can be restricted without a correction circuit or an additional adjustment mechanism for fine adjustment of the inclination angle. Also, by limiting the range of the magnification of the optical system, an abrupt increase in the diameter of a laser beam spot in the main scanning direction and the sub-scanning direction can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A multi-beam scanning unit comprising:
a light source having a plurality of light emitting portions, each light emitting portion to emit a laser beam; and
a beam deflector to deflect each of the laser beams emitted from the light emitting portions in a main scanning direction of a photosensitive medium,
wherein the light emitting portions are arranged in a line on a light exit surface of the light source, and an angle A between a section on the light exit surface of the light source corresponding to a sub-scanning direction that is a direction in which the photosensitive medium moves and a section connecting the light emitting portions satisfies Inequality 1 or Inequality 2 which are:
0°<A≦35° [Inequality 1]
55°≦A≦80° [Inequality 2].

2. The multi-beam scanning unit as claimed in claim 1, wherein a distance between the light emitting portions that neighbor each other is within less than 100 μm.

3. The multi-beam scanning unit as claimed in claim 2, wherein a distance between the light emitting portions that neighbor each other is within less than 14 μm.

4. The multi-beam scanning unit as claimed in claim 1, wherein the light source is formed of an edge emitting laser diode or a vertical cavity surface emitting laser diode.

5. The multi-beam scanning unit as claimed in claim 1, wherein a distance in the main scanning direction between centers of spots of the laser beams respectively emitted from the light emitting portions that neighbor each other and simultaneously formed on the photosensitive medium is 1/2 dots or more based on a resolution of an optical system

6. The multi-beam scanning unit as claimed in claim 1, wherein a distance in the sub-scanning direction between centers of spots of the laser beams respectively emitted from the light emitting portions that neighbor each other and simultaneously formed on the photosensitive medium is within a range of ±20% based on a resolution of an optical system.

7. The multi-beam scanning unit as claimed in claim 1, further comprising an f-θ lens that corrects the beams deflected by the beam deflector at different magnifications according to the main scanning direction and the sub-scanning direction.

8. The multi-beam scanning unit as claimed in claim 7, further comprising:
at least one cylindrical lens to condense an incident beam with respect to a direction corresponding to the main scanning direction and/or the sub-scanning direction; and
a collimating lens to condense the laser beams respectively emitted from the light emitting portions in to a parallel beam or a convergent beam,
wherein the at least one cylindrical lens and the collimating lens are provided between the light source and the beam deflector.

9. The multi-beam scanning unit as claimed in claim 8, wherein a magnification of a laser beam spot in the sub-scanning direction emitted onto the photosensitive medium is within a range of about 1.5× to 18×.

10. A multi-beam scanning apparatus comprising:
a light source having a plurality of light emitting portions to emit light beams through a light exit plane thereof onto a photosensitive medium, centers of the light emitting portions being arranged along a first line on the light exit plane; and
a beam guide unit to guide the light beams from the light source to the photosensitive medium, wherein an angle between the first line and a second line corresponding to a sub-scanning direction in which the photosensitive medium moves is set to a predetermined angle to eliminate interference between the light emitting portions.

11. A method of correcting interference in a multi-beam scanning device, the method comprising:
emitting light from a light source having two light emitting portions through a light exit plane onto a photosensitive medium, centers of the light emitting portions being arranged along a first line on the light exit plane; and
controlling to within a predetermined amount an angle between the first line and a second line corresponding to a sub-scanning direction in which the photosensitive medium moves to eliminate interference between the light emitting portions.

12. The method of claim 11, comprising:
controlling a light source pitch, the light source pitch being a distance on the first line between the centers of the two light emitting elements on the light exit plane of the light source.

13. The method of claim 12, wherein the light source pitch is controlled to be less than 100 μm.

14. The method of claim 11, comprising:
forming at least two beam spots on the photosensitive medium with light emitted from the two light emitting elements;
forming a first scanning line having plural beam spots in a main scanning direction;
forming a second scanning line having plural beam spots on the photosensitive medium, the first and second scanning lines being at a distance from each other in the sub-scanning direction; and
controlling an optical magnification in the sub-scanning direction, the optical magnification being a ratio between the distance between the first and second scanning lines on the photosensitive medium and a distance between the centers of the two light emitting portions on the light exit plane in the sub-scanning direction.

15. The method of claim 14, comprising:
controlling a size of a the plural beam spots formed on the photosensitive medium.

16. The method of claim 14, wherein the optical magnification is controlled to be with 1.5× to 18× and the angle is controlled to be between 0°<A≦35° or 55°≦A≦80°.
